(19) United States
(12) Patent Application Publication
(10) Pub. No.: US 2017/0050687 A1
(43) Pub. Date: Feb. 23, 2017

(54) Track Roller Stationary Collar

(71) Applicant: CATERPILLAR INC., Peoria, IL (US)

(72) Inventors: Gregory J. Kaufmann, Metamora, IL (US); Mircea Dumitru, Washington, IL (US); Darren Brent Antoine, East Peoria, IL (US)

(73) Assignee: CATERPILLAR INC., Peoria, IL (US)

(21) Appl. No.: 14/830,854

(22) Filed: Aug. 20, 2015

(51) Int. Cl. B62D 55/088; B62D 55/15

(52) U.S. Cl. CPC B62D 55/088; B62D 55/15

(57) ABSTRACT

A stationary collar is presented for use within a track roller. The stationary collar may have a hole in which it may attach to a stationary shaft of the track roller. The stationary collar may have a unique asymmetrical design in which the first portion of the stationary collar is different from the second portion of the stationary collar. This asymmetrical design helps prevent foreign debris from entering the track roller. Additionally, the asymmetrical design helps in aiding the track roller in expunging foreign debris from the track roller when the track roller is in operation.

### TECHNICAL FIELD

The present disclosure generally relates to track rollers of a track-type machine, and more particularly relates to a stationary collar for protecting the interior of the track roller.

### BACKGROUND

Track-type machines are in widespread use in construction, mining, forestry, and other similar industries. The undercarriage of such track-type machines utilizes track assemblies, rather than wheels, to provide ground-engaging propulsion. Such track assemblies may be preferred in environments where creating sufficient traction is problematic, such as the environments identified above. Specifically, rather than rolling across a work surface on wheels, track-type machines utilize one or more track assemblies that include an endless loop of coupled track links defining exterior surfaces, which support ground-engaging track shoes, and interior surfaces that travel about one or more rotatable track-engaging elements, such as, drive sprockets, idlers, tensioners, and rollers, for example.

Typical track-type machines usually include a roller assembly as part of the undercarriage of the track-type machine. The roller assembly typically has a multitude of track rollers positioned in a linear fashion along the path of the roller assembly. The track forming the traction mechanism for a track-type machine may then be affixed to the roller assembly in such a fashion as to allow the track to move across the track rollers when the track-type machine is in operation. The roller assembly provides a structured path for the track to follow and allows for easy, guided movement of the track when the track-type machine is in use.

Like any mechanical component, the track rollers of the undercarriage experience wear and fatigue during operational use of the track-type machine. Many different factors can affect the wear of the rollers including dozing and load pushing, ripping and drawbar actions, and general loading and excavating. The terrain in which a track-type machine is in operation can also greatly affect the wear of the undercarriage. During some operations, track-type machines may utilize a packing technique or be subjected to unnecessary packing due to the conditions of the terrain. During operation, material can stick to and pack between the components of the undercarriage such as the track roller, links, sprocket teeth, and bushings. This packing prevents parts of the undercarriage from engaging correctly. This may cause higher loads within the undercarriage and increase the wear rates of the components.

To prevent some of the additional wear a track-type machine may be subjected to due to packing, some general solutions have been supplied by the industry to mitigate damage. Special punched shoes may be used in certain situations to help relieve extricable material such as wet sand, clay or snow. Additionally, it is recommended to clean the undercarriage of the track-type machine regularly to remove garbage, twigs, stones, and debris that cannot be extruded through center punched shoes. Furthermore, in some applications the use of a roller guard to protect the roller assembly of the undercarriage may be used. However, the roller guard may have the unintended purpose of increasing the effects of packing if it is not used in the correct terrain conditions.

Additionally, previous attempts such as Japanese Patent Application JP2000346205A have tried to address the issue of packing within track rollers. In this application a labyrinth seal is introduced to prevent foreign material such as soil from entering the internal components of the track rollers. While this solution may aid in the prevention of the introduction of foreign material into the track roller, this application does not address the overall design flaws of the track roller components which may be redesigned to prevent foreign material from entering and at the same time being able to expel foreign material which may have already entered the labyrinth.

Although these methods may be effective in minor respects to eliminate some wear caused by packing, these solutions do not address the actual design of the track rollers which are used within the undercarriage. Therefore, it would be advantageous to develop a track roller of sufficient robustness and design to relieve the track roller of additional wear exuded onto the track roller from packing. Additionally, it would be advantageous to develop such a track roller which would help in extruding foreign material from the track roller during operation.

### SUMMARY OF THE DISCLOSURE

In one aspect of the disclosure, a stationary collar is disclosed for use on a track roller. The stationary collar may have a first portion and a second portion of the stationary collar. The second portion of the stationary collar may be an asymmetrical design when compared to the first portion of the stationary collar. Together, the first and second portions define a hole which operates to receive a stationary shaft to affix the stationary collar to the stationary shaft.

In another aspect of the disclosure, a track roller is disclosed for use within an undercarriage of a track-type machine. The track roller may have a stationary shaft. A bearing may be positioned around the center portion of the stationary shaft. A roller shell may then be positioned around the bearing. The track roller may also have a stationary collar attached to each end of the stationary shaft and secured to the stationary shaft by a lock pin. The stationary collar may have a first portion and a second portion, wherein the second portion of the stationary collar has an asymmetrical design when compared to the first portion of the stationary collar. A thrust ring may also be present around the stationary shaft and located between the stationary collar and the roller shell. Additionally, a first metal face seal may be located within a first vacant section of the stationary collar. The first meal face seal may have a first sealing component in contact with the first metal face seal and the stationary collar. Furthermore, a second metal face seal may be present. The second metal face seal may be located in a second vacant portion between the stationary collar and the roller shell. The second metal face seal may have a second sealing component in contact with the second metal face seal and the roller shell.

In yet another aspect of the disclosure, a method to remove debris from a track roller during operation of a track-type machine is disclosed. First, a track roller having a roller shell and a stationary collar attached to a stationary shaft is provided. The stationary collar is designed to have a first portion and a second portion wherein the second portion of the stationary collar is an asymmetrical design when compared to the first portion of the stationary collar. Next, the debris is ingested into an upper labyrinth formed between the first portion of the stationary collar and the roller shell. Then, the roller shell rotates so that the debris ingested into the upper labyrinth rolls along with the roller shell as the roller shell rotates. The debris is then dislodged from the track roller as the roller shell rotates the debris toward a bottom labyrinth. The bottom labyrinth being formed from a larger space between the stationary collar and the roller shell. Finally, the debris is expunged from the track roller through the aid of gravity as the roller shell rotates.

These and other aspects and features of the present disclosure will be more readily understood when reading the following detailed description taken in conjunction with the accompanied drawings.

### BRIEF DESCRIPTION OF THE DRAWINGS

FIG. 1 is a side view of a track-type machine in accordance with one embodiment of the present disclosure.

FIG. 2 is perspective view of a roller assembly which may be part of an undercarriage of a track-type machine in accordance with one embodiment of the present disclosure.

FIG. 3 is an angled, cross-sectional side view of a track roller in accordance with one embodiment of the present disclosure, and taken along line 3-3 of FIG. 2.

FIG. 4 is cross sectional view of a stationary collar, a roller shell and the interior components of a track roller in accordance with one embodiment of the present disclosure, and taken along line 4-4 of FIG. 2

FIG. 5 is a front view of an asymmetrically designed stationary collar and the roller shell in accordance with one embodiment of the present disclosure.

FIG. 6 is a front view of an asymmetrically designed stationary collar and the roller shell in accordance with another embodiment of the present disclosure.

FIG. 7 is a flowchart that exemplifies one method to remove debris from a track roller during operation of a track-type machine in accordance with one embodiment of the present disclosure.

It should be understood that the drawings are not necessarily to scale and that the disclosed embodiments are illustrated diagrammatically and in partial views. It should be further understood that this disclosure is not to be limited to the particular embodiments illustrated herein.

### DETAILED DESCRIPTION

The present disclosure provides a stationary collar design and configuration of a track roller used within an undercarriage of a track-type machine. Examples of such machines include machines used for construction, mining, forestry, and other similar industries. In some embodiments, the machine can be a dozer, loader, or excavator, or any other on-highway or off-highway vehicle having a track-type undercarriage with first and second track chain assemblies disposed on opposing sides of the undercarriage. The track assemblies can be adapted to engage the ground or other surface to propel the track-type machine over the surface.

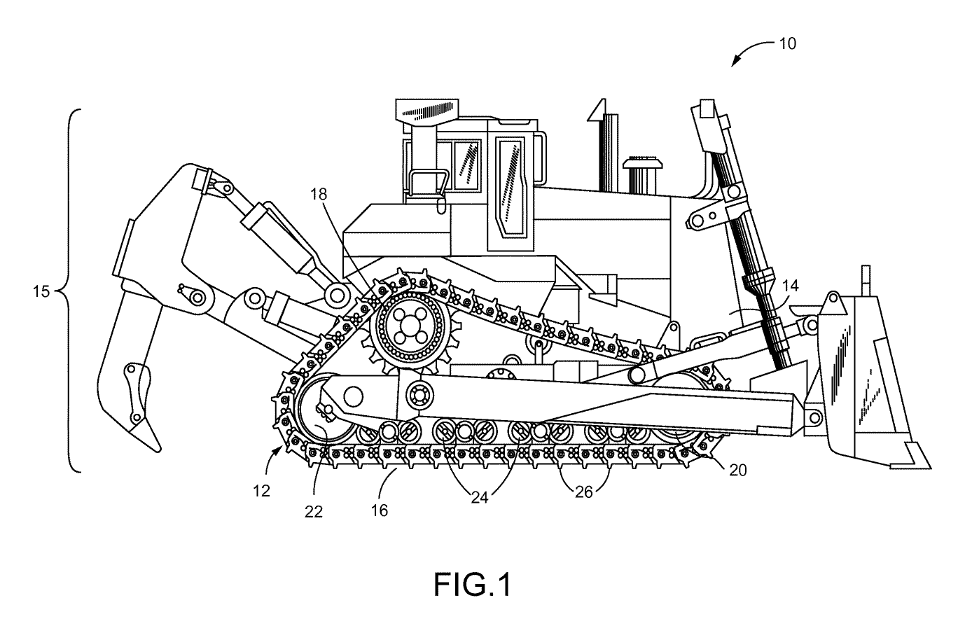

Referring now to the drawings, and with specific reference to FIG. 1, shows an exemplary embodiment of a machine 10 having an undercarriage 12. The machine 10 may also be referenced herein as a track-type machine 15. In different embodiments, the machine 10 may be a dozer, loader, or excavator, or any other on-highway or off-highway vehicle. The machine 10 includes a frame 14 having a first track chain assembly 16 disposed on the right side of the machine 10, and a second track chain assembly (not shown) disposed on the left side of the machine 10. Together, the track assemblies are adapted to engage the ground or other surface to propel the machine 10 over the surface. It should be appreciated that the track chain assemblies 16 of the machine 10 may be similar and, further, may represent mirror images of one another. As such, only the first track chain assembly 16 will be described herein, and it should be understood that the description of the first track chain assembly 16 is applicable to the second track chain assembly, as well.

The track chain assembly 16 extends about a plurality of rolling elements such as a drive sprocket 18, a front idler 20, a rear idler 22, and a plurality of track rollers 24. The track chain assembly 16 includes a plurality of ground-engaging track shoes 26 for engaging the ground or other surface and propelling the machine 10 over the surface. During typical operation of the undercarriage 12, the drive sprocket 18 is driven in a clockwise rotational direction as shown in FIG. 1 to drive the track chain assembly 16, and thus the machine 10, in a forward direction, and in a counterclockwise rotational direction to drive the track chain assembly 16 and thus the machine 10 in a reverse direction. The drive sprocket 18 of the undercarriage 12 can be independently operated to create a velocity differential that allows the machine 10 to turn. While the machine 10 is illustrated in the context of a track-type machine, it should be appreciated that the present disclosure is not thereby limited, and that a wide variety of other machines having tracks are also contemplated within the present context. For example, in other embodiments, the track chain assembly 16 can be included in a conveyor system as a track for transmitting torque between rotating elements, or in any other application known to those skilled in the art.

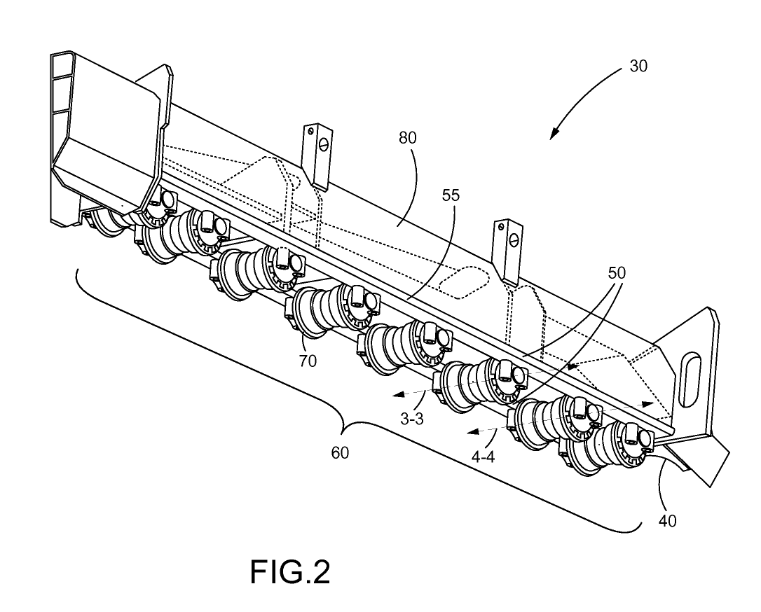

Referring now to FIG. 2, the track roller assembly 30 of the undercarriage 12 is depicted. The track roller assembly 30 may have an assembly housing portion 40 that runs the length of the track roller assembly 30. At a one end of the assembly housing portion 40, the assembly housing portion 40 may be configured to attach to the track-type machine 15 into a mounting bracket near the front idler 20 of the undercarriage 12. At the opposite end, the assembly housing portion 40 may be configured to attach to the track-type machine 15 by being placed over the rear idler 22 and secured to the undercarriage 12. As this is only one possible configuration in which the track roller assembly 30 may be attached to the undercarriage 12 of the track-type machine 15, it should be appreciated that other mounting configurations can be employed to attach the track roller assembly 30 depending on the spatial and undercarriage configurations of the specific track-type machine 15 in which the track roller assembly 30 will be used.

The track roller assembly 30 may also have a plurality of guide rails 50 running from between the two mounting ends of the assembly housing portion 40. The guide rails 55 provide a platform on to which a plurality of track rollers 60 may be affixed. The number of track rollers 70 may vary for each track roller assembly 30 dependent on the size and shape of the undercarriage 12 of the track-type machine 15. Respectively, smaller track-type machines 15 would have a smaller number of track rollers 70 attached to the plurality of guide rails 50 than larger track-type machines 15. Additionally a roller assembly guard 80 may be present. The roller assembly guard 80 is positioned to cover the upper exposed portion of the plurality of track rollers 60 attached along the plurality of guide rails 50. The roller assembly guard 80 aids in preventing foreign material from packing against the plurality of track rollers 60, and thereby improving the operative work life cycle of the track rollers 70 by persevering them from increased wear and unnecessary damage.

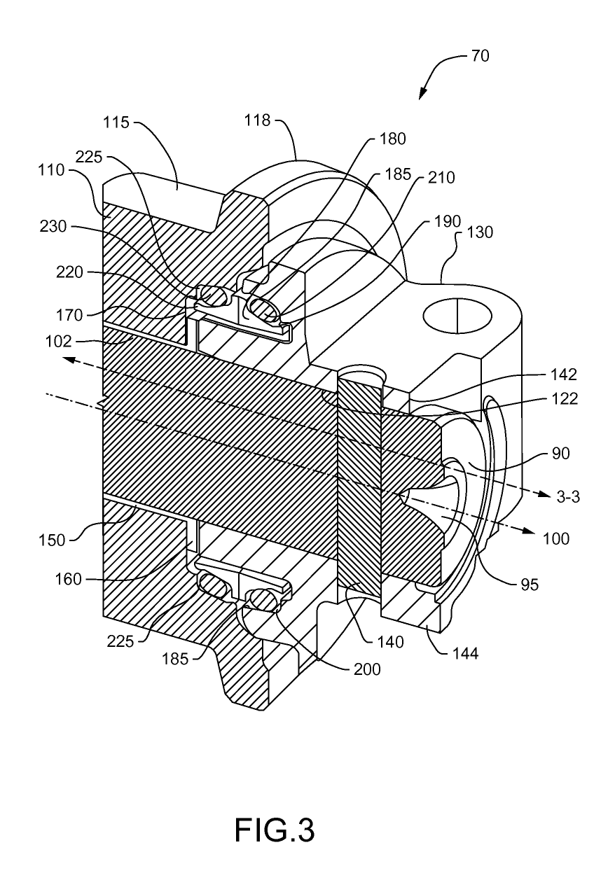

Turning now to FIG. 3, an angled cross-sectional view of a track roller 70 of the plurality of track rollers 60 is depicted. Each track roller 70 of the plurality of track rollers 60 may have the same components and configuration represented by FIG. 3. While shown only depicting one outside face of the track roller 70, it should be understood that the track roller 70 as depicted has a symmetrical design. Therefore, it is understood that the track roller 70 will contain the same components and design configuration on the opposite side of the track roller 70 which is not depicted within FIG. 3.

The track roller 70 contains a stationary shaft 90 within the center 95 of the track roller 70. The stationary shaft 90 operates to hold the multiple components of the track roller 70 together on a common axis 100. Being the center 95 of the track roller 70, the stationary shaft 90 presents a platform upon which the other components of the track roller 70 can be place and extend radially outward from the common axis 100. Above the center portion 102 of the stationary shaft 90 a roller shell 110 is present. The roller shell 110 provides the main operative component of the track roller 70. The roller shell 110 is configured and designed in such a fashion that the roller shell 110 may rotate either clockwise or counter-clockwise around the stationary shaft 90. The exposed edges 115 of the roller shell 110 may be in contact with the track chain assembly 16 of the track-type machine 15. The roller shell 110 may be designed in such a fashion that the track chain assembly 16 of the track-type machine 15 may easily roll over and along the track roller 70 when the track-type machine 15 is in operation. Additionally, the roller shell 110 provides a guidance advantage to the track chain assembly 16. Notched levels 118 of the roller shell 110 allow for the track chain assembly 16 to fit within the notched levels 118 providing the track chain assembly 16 a straight rolling path during operation. These notched levels 118 aid in preventing the track chain assembly 16 of the track-type machine 15 from slipping off the track roller assembly 30 and ceasing operation of the track-type machine 15.

Above the end section 122 of the stationary shaft 90, a stationary collar 130 is present. Like the roller shell 110, the stationary collar 130 also completely encompasses the stationary shaft 90. The stationary collar 130 is located at each end section 122 of the track roller 70 and helps secure the internal components, like the roller shell 110, onto the stationary shaft 90. The dimensions and design of the stationary collar 130 provide unique advantages to the presently disclosed track roller 70 and will be discussed in greater detail below. A locking pin 140 may be present running perpendicular to the common axis 100. The locking pin 140 may travel through an upper or first portion 142 of the stationary collar 130, into and through the stationary shaft 90, and ending through a bottom or second portion 144 of the stationary collar 130. The locking pin 140 may be held in place through any type of affixing means including friction and is operable to help keep the track roller components connected around the stationary shaft 90. The locking pin 140 also aids in preventing the track roller components from breaking off and dislodging from the stationary shaft 90.

To allow the roller shell 110 to rotate around the stationary shaft 90 a radial bearing 150 may be present. The radial bearing 150 is located between the roller shell 110 and the stationary shaft 90 encompassing the center portion 102 of the stationary shaft 90. The radial bearing 150 allows for the roller shell 110 to easily rotate about the stationary shaft 90 when the track-type machine 15 is in operation. Before the stationary collar 130 comes into contact with the roller shell 110, a thrust ring 160 is provided. The thrust ring 160 is located between the stationary collar 130 and the roller shell 110 and is a disc shaped ring which fits over the stationary shaft 90. The thrust ring 160, like the radial bearing 150, enhances movement of the roller shell 110 axially around the stationary shaft 90. This axial motion of the roller shell 110 aided by the thrust ring 160 helps expel foreign material from the track roller 70 and will be discussed in greater detail below. The thrust ring 160 may also have a bearing type mechanism contained within the thrust ring 160 allowing the roller shell 110 to easily rotate when in contact with the thrust ring 160. Additionally, the thrust ring 160 helps inhibit the stationary collar 130 from affecting the rotation of the roller shell 110 since the stationary collar 130 is configured to not move when attached to the track roller 70. To help aid the rotation and performance of the roller shell 110, a lubricant 170 may be added. The lubricant 170 may be oil, grease, or any other type of lubricant 170 which can ease the rotation of the roller shell 110. The lubricant 170 may be spread to aid both the radial bearing 150 and the thrust ring 160 as well.

While the lubricant 170 helps provide easy rotation of the roller shell 110, the lubricant 170 can easily escape from the track roller 70 through the space between the roller shell 110 and the stationary collar 130. Therefore, a blocking mechanism of some type should be placed to prevent the lubricant 170 from leaking out. In an embodiment of the present disclosure, a metal face seal is used. The metal face seal is configured for use within rotation applications. In the depiction presented in FIG. 3, two metal face seals are used. The first metal face seal 180 is positioned to fit around the stationary collar 130 and the placed within a first vacant section 185 of the track roller 70. The first vacant section 185 of the track roller 70 may have both a top collar housing 190 and a bottom collar housing 200 of the stationary collar 130. The first metal face seal 180 may also have a first sealing component 210 to prevent lubricant 170 leakage. The first sealing component 210 may be an O-ring, elastomer, or any other type of material that is sufficiently flexible and robust to provide a complete seal between components. In an embodiment of the present disclosure, the first sealing component 210 is a toric. The first sealing component 210 is place around the first metal face seal 180 and is in contact with both the first metal face seal 180 and the first portion 142 of the stationary collar 130. This first metal face seal 180, in the disclosed embodiment, is a static seal and not operable to move with the roller shell 110 when the track roller 70 is in operation.

Additionally a second metal face seal 220 may be present. The second metal face seal 220 may also be placed around the stationary collar 130 enveloping the stationary shaft 90. The second metal face seal 220 is positioned in such a way that the second raised top edge 222 of the second metal face seal 220 matches a first raised top edge 224 of the first metal face seal 180. Like the first metal face seal 180, the second metal face seal 220 may have a second sealing component 230. In an embodiment of the present disclosure, the second sealing component 230 of the second metal face seal 220 is a toric like that disposed around the first metal face seal 180. However, unlike the first metal face seal 180, the second metal face seal 220 does not fit into the stationary collar 130. The second metal face seal 220 is configured to fit into a second vacant section 225 of the track roller 70 when it is assembled. The second vacant section 225 is located between the stationary collar 130 and the roller shell 110. The second sealing component 230 of the second metal face seal 220 is then in contact with both the second metal face seal 220 and the roller shell 110. This contact prevents the lubricant 170 from escaping the internal lubricated components of the track roller 70. Unlike the first metal face seal 180, the second metal face seal 220 is not static in nature. The second metal face seal 220 is configured to rotate along with the roller shell 110 facing the stationary collar 130. The lubricant 170 contained within the interior of the track roller 70 aids in this rotation of the second metal face seal 220.

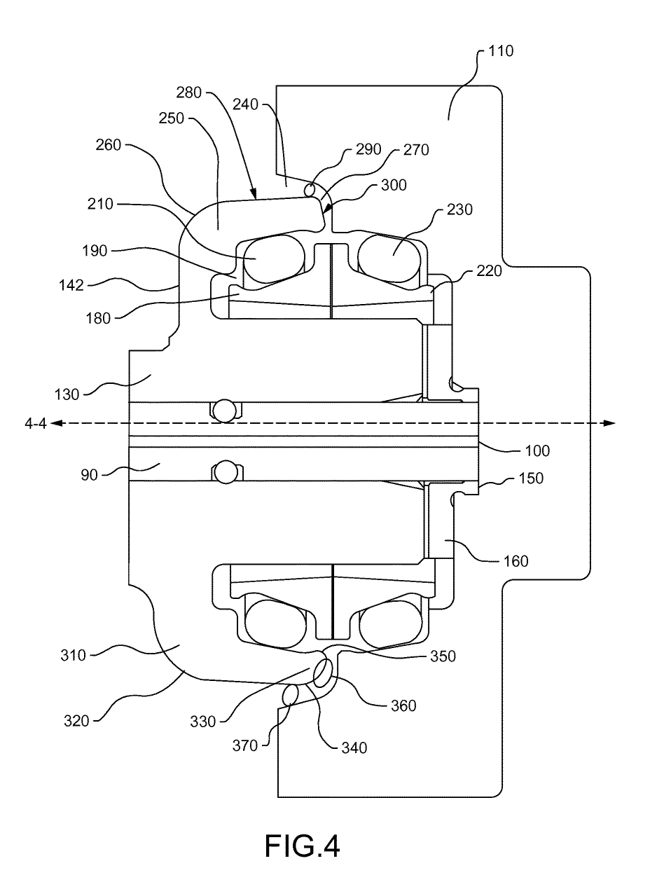

Turning now to FIG. 4, the geometry of the stationary collar 130 is depicted in greater detail. As with FIG. 3, the important internal components of the track roller 70 are depicted as well. These components include: the radial bearing 150, thrust ring 160, first sealing component 210, second sealing component 230, first metal face seal 180, second metal face seal 220, stationary shaft 90, roller shell 110, and the stationary collar 130. When the track roller 70 is assembled, the stationary collar 130 rests in close proximity to the roller shell 110. The space between the stationary collar 130 and the roller shell 110 is called a labyrinth 240. The labyrinth 240 is present around the entirety of the track roller 70. The stationary collar 130, in an embodiment of the present disclosure, is manufactured to have a unique geometric design which helps facilitate the removal of foreign debris, such as dirt, mud, sand, snow, or clay, from the labyrinth 240 of the track roller 70. If foreign debris enters the labyrinth 240, the debris can make its way into the track roller 70 and be in contact with the first and second metal face seals 180 and 220 as well as the first and second sealing components 210 and 230. This may cause unintended and additionally wear to the track roller 70. Furthermore, the debris may also lodge itself past the first and second metal face seals 180 and 220 and the first and second sealing components 210 and 230 and mix with the lubricant 170 within the track roller 70. This also adds to unnecessary wear and unintended damage affecting the interior of the track roller 70.

The first portion 142 of the stationary collar 130 is designed in such a way as to inhibit foreign debris from entering the labyrinth 240. The first portion 142 of the stationary collar 130 has a upper protrusion 250 above the top collar housing 190 of the stationary collar 130 where the first metal face seal 180 and the first sealing component 210 fit. Typical stationary collars 130 have a top surface 260 of the upper protrusion 250 being flat and a side face 270 of the upper protrusion 250 being flat and at a perpendicular angle to the top surface 260 of the upper protrusion 250. However, in an embodiment of the present disclosure, the top surface 260 of the upper protrusion 250 is not flat, but rather a ramped surface 280. The ramped surface 280 provides an incline from one end of the top surface 260 to the other end of the top surface 260. Being a ramped surface 280, the top surface 260 of the upper protrusion 250 helps restrict foreign debris from resting on the top surface 260 of the upper protrusion 250, thereby minimizing the possibility of the foreign debris entering the track roller interior. The ramped surface 280 allows for gravity to expel debris off the top surface 260 of the upper protrusion 250 and away from the labyrinth 240 leading to the interior of the track roller 70. Also, have having a ramped surface 280, and not a flat surface, the ramped surface 280 of the top surface 260 of the upper protrusion 250 creates a restricted upper opening 290 of the labyrinth 240. By creating a restricted upper opening 290 of the labyrinth 240, this also inhibits the entrance of foreign debris into the interior of the track roller 70.

On the side face 270 of the upper protrusion 250 of the stationary collar 130 an angled face 300 is present. Like the ramped surface 280 and the restricted upper opening 290 of the labyrinth 240, the angled face 300 also help in preventing foreign material from entering the interior of the track roller 70. The angled face 300 functions a bit differently than the ramped surface 280 to help expel foreign debris from entering the track roller 70. The angled face 300 is angled in reference to the roller shell 110 opposite the angled face 300. The roller shell 110 opposite the angled face 300 may be at a horizontal position in reference to the angled face 300. If foreign debris has made it to this point within the labyrinth 240, the angled face 300 helps trap larger pieces of the foreign material between the angled face 300 and the roller shell 110. The material can then be expelled by a pumping action which can occur when the roller shell 110 rotates with the aid of the thrust ring 160 and bearing 150 in reference to the stationary collar 130. Additionally, the angle of the angled face 300 provides an easy path for the foreign material to travel as it is expelled from the track roller 70 through the labyrinth 240. The details of the pumping action and how this may expel foreign material will be disclosed in greater detail below.

Still referring to FIG. 4, there is also a lower protrusion 310 of the stationary collar 130. The lower protrusion 310 of the stationary collar 130 is located below the bottom collar housing 200 of the stationary collar 130 where the first metal face seal 180 and the first sealing component 210 fit. Unlike the upper protrusion 250 of the stationary collar 130 the lower protrusion 310 of the stationary collar 130 has a different geometric design. The bottom surface 320 of the lower protrusion 310 of the stationary collar 130 may be a ramped surface similar to the top surface 260 of the upper protrusion 250. However, the bottom surface 320 may also be flat as no foreign debris should be resting on the bottom surface 320 as gravity will allow any foreign material to dislodge and fall off the bottom surface 320 of the lower protrusion 310 of the stationary collar 130. The lower side face 330, however, has a different configuration in comparison to the side face 270 of the upper protrusion 250 of the stationary collar 130. The lower side face 330 may have a rounded face 340 with the top area of the rounded face 340 forming a bulge 350 facing the first metal face seal 180. The rounded face 340 and the bulge 350 allow for foreign material to easily slip out of the labyrinth 240 between the rounded face 340 and the roller shell 110. The pumping action and gravity help expel foreign material from the labyrinth 240 between the rounded face 340 and the roller shell 110 during operation. Furthermore, the rounded face 340 may have a plurality of notches 360 formed into the outer edges of the rounded face 340. This plurality of notches 360 further facilitates the removal of foreign debris from the labyrinth 240 between the rounded face 340 and the roller shell 110. Additionally, the opening of the bottom labyrinth 370 may be larger than the restricted upper opening 290 of the labyrinth 240. By providing a larger opening of the bottom labyrinth 370, the foreign debris may easily fall out of the labyrinth 240 through the aided effects of gravity.

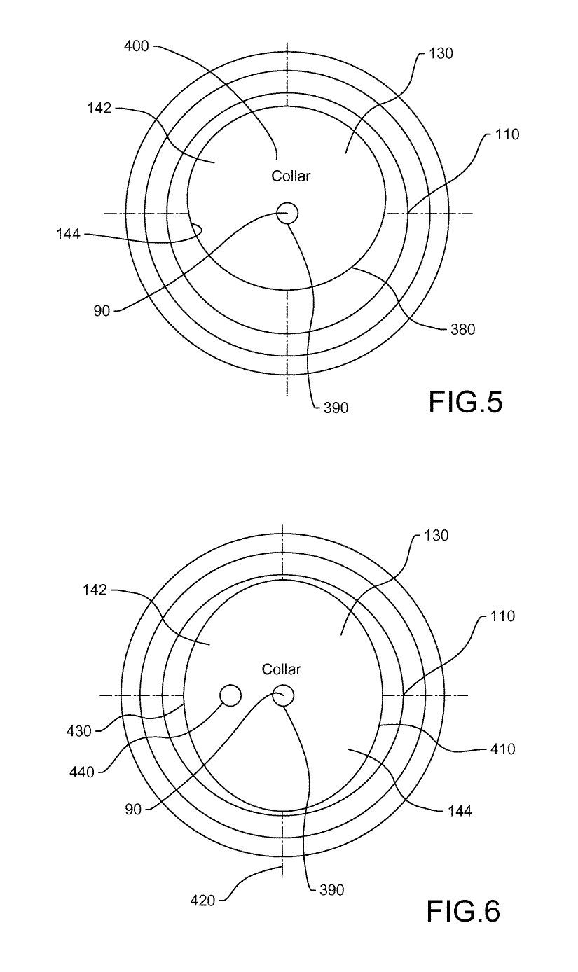

Turning now to FIG. 5, a side view of the stationary collar 130 is presented against the roller shell 110. The stationary collar 130 typically will have a circular design having a diameter to match the diameter of the roller shell 110. Therefore, both the stationary collar 130 and the roller shell 110 would be symmetrical to one another. However, the stationary collar 130 in an embodiment of the present disclosure may have an asymmetrical design 380. In this asymmetrical design 380 presented in FIG. 5, the stationary collar 130 and the roller shell 110 are still both connected to the stationary shaft 90 through a hole 390 in each the stationary collar 130 and the roller shell 110. The stationary collar 130, will fit onto the stationary shaft 90 offset from the geometric center 400 of the stationary collar 130. A stationary collar 130 positioned in this fashion would have a larger first portion 142 than the second portion 144 of the stationary collar 130. Therefore, foreign debris that may become wedged between the stationary collar 130 and the roller shell 110 at the first portion 142 of the stationary collar 130 would easily become dislodged as the roller shell 110 rotates toward the second portion 144 of the stationary collar 130.

As seen in FIG. 6, the stationary collar 130 may also have an oval design 410. Like the stationary collar 130 of FIG. 5, the stationary collar 130 of FIG. 6 is asymmetrical in design and is not designed to match the complete circumference of the roller shell 110. Like the previous embodiment, this stationary collar 130 and the roller shell 110 are connected through a hole 390 to the stationary shaft 90. The stationary collar 130 having the oval design 410 may have a same diameter of the roller shell 110 consistent through the vertical axis 420 of each the stationary collar 130 and the roller shell 110. However, the diameter of the stationary collar 130 would be smaller than that of the roller shell 110 through the horizontal axis 430 of each the stationary collar 130 and the roller shell 110. Using this oval design 410, the stationary collar 130 would have a similar first and second portion 142 and 144, however the side portions 440 of the stationary collar 130 would be smaller than the first and second portions 142 and 144. As the roller shell 110 rotates in reference to the stationary collar 130, foreign material may be expelled from the side portions 440 of the stationary collar 130.

### INDUSTRIAL APPLICABILITY

From the foregoing, it may be appreciated that the track roller disclosed herein may have industrial applicability in a variety of setting such as, but not limited to, use in track-type machines operating in a heavy foreign debris environment such as dirt, sand, or snow. Such a track roller may also be used in clean operation environments as the disclosed track roller functions easily in clean operations with the additional advantage of protecting the track rollers if foreign debris is present. Such a track roller can be employed in any type of industry that facilitates the use track-type machines. Such industries may include manufacturing earth-moving equipment, building construction, military vehicles, recreational off road vehicles, rail, agriculture, shipbuilding, police and military surveillance machines, drainage and sewer maintenance, underwater maintenance or any like environment in which a track-type machine may be needed or operated.

In operation, the track roller 70 is designed in such a way to easily prevent foreign material from entering the internal components of the track roller 70. Additionally, the track roller 70 may easily expel foreign material as the roller shell 110 rotates in reference to the stationary collar 130. This rotation provides a pumping action which is effective at removing foreign material from the labyrinth 240.

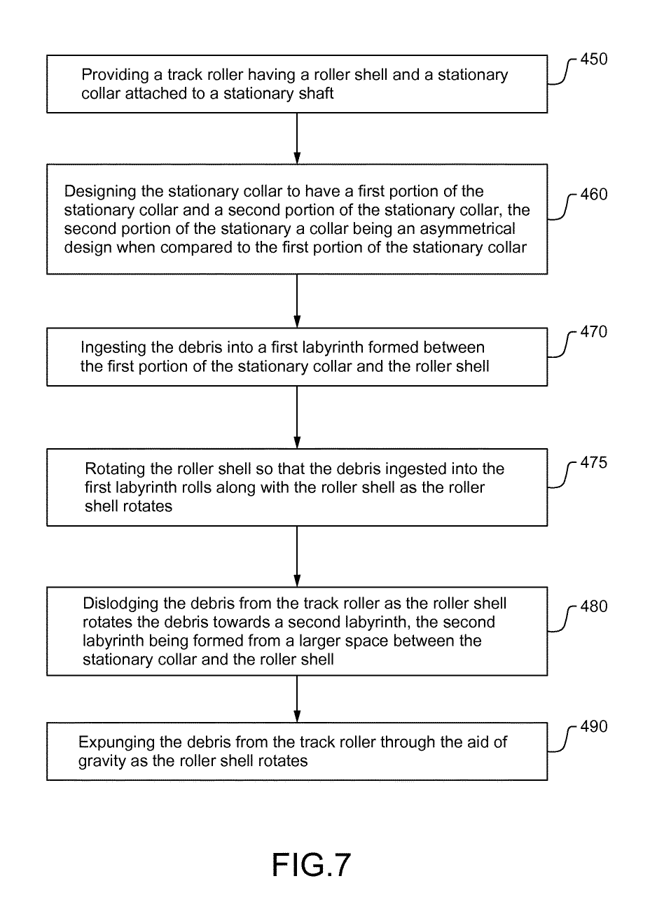

An exemplary method according to the present disclosure is shown in flow chart format in FIG. 7. As shown in block 450, a track roller 70 is provided. The track roller 70 may have all the interior components as described above including a stationary collar 130 and a roller shell 110 which is attached to a stationary shaft 90. The stationary collar 130, as described above, is designed to have a specific geometric design as seen in block 460. Looking face on the stationary collar 130 the first portion 142 of the stationary collar 130 can be envisioned to be at a twelve o'clock position while the second portion 144 of the stationary collar 130 would be at a six o'clock position. Therefore, the side portions 440 of the stationary collar 130 may be envisions being at each a three o'clock and a nine o'clock positions. As seen in block 470, debris may be ingested in the restricted upper opening 290 of the labyrinth 240 formed between the first portion 142 of the stationary collar 130 and the roller shell 110. The debris may enter the labyrinth 240 at approximately the twelve o'clock position. As stated above, the first portion 142 of the stationary collar 130 has unique features such as an angled face 300 and a ramped surface 280 that may add in removing this ingested debris. Then, in block 475, the roller shell 110 is rotated so that the debris ingested into the labyrinth 240 rolls along with the roller shell 110. The roller shell 110 rotates with the aid of the thrust ring 160 and the bearing 150 axially in reference to the stationary shaft 90.

Next, in block 480, debris from the track roller 70 is dislodged as the roller shell 110 rotates toward the bottom labyrinth 370. As the roller shell 110 rotates debris may become lodged between the angled face 300 of the stationary collar 130 and the roller shell 110. The roller shell 110 then pumps the debris along the rotational path of the roller shell 110. This effectively moves the debris from the twelve o'clock position to either the three or nine o'clock positions, depending on the rotation, and then finally the six o'clock position. During this axial rotation, the debris can be forced out of the interior of the track roller 70 through the path provided by the angled face 300.

As the remaining debris travels toward the second portion 144 of the stationary collar 130, the second portion 144 has a different design and functionality to aid in removing the remaining debris. This may include the rounded face 340 as well as a larger bottom labyrinth 370 opening formed between the roller shell 110 and the stationary collar 130. As debris moves from the twelve o'clock position and the restricted upper opening 290, toward the bottom labyrinth 370, the labyrinth 240 increases in size. As the size increases, the debris will easily dislodge from the labyrinth 240 as it can no longer maintain friction sufficient to remain within the labyrinth 240. The change in the geometric design of the stationary collar 130 may be gradual from the twelve o'clock reference position to the six o'clock position, or it may be abrupt at a set position along the stationary collar 130 when the first portion geometry will change into the second portion geometry. Finally, in block 490, after utilizing this geometry, the labyrinth 240, and gravity, the debris is expunged from the track roller 70.

While the foregoing detailed description has addressed only specific embodiments, it is to be understood that the scope of the disclosure is not intended to be limiting. Thus, the breadth and spirit of this disclosure is intended to be broader than any of the embodiments specifically disclosed and/or encompassed within the claims appended hereto.

What is claimed is:

1. A stationary collar for use on a track roller, the stationary collar comprising:
a first portion; and
a second portion, the second portion of the stationary collar being an asymmetrical design when compared to the first portion of the stationary collar, the first and second portions defining a hole operable to receive a stationary shaft to affix the stationary collar to the stationary shaft.

2. The stationary collar of claim 1, wherein the first portion of the stationary collar has an upper protrusion and a top collar housing as part of the first portion of the stationary collar.

3. The stationary collar of claim 1, wherein the second portion of the stationary collar has a lower protrusion and a bottom collar housing as part of the second portion of the stationary collar.

4. The stationary collar of claim 2, wherein the upper protrusion has a top surface, the top surface being a ramped surface providing an incline from one end of the upper protrusion to the other end of the upper protrusion.

5. The stationary collar of claim 2, wherein the upper protrusion has a side face, the side face being an angled face providing an incline from one end of the side face to the other end of the side face.

6. The stationary collar of claim 3, wherein the lower protrusion has a lower side face, the lower side face being a rounded face.

7. The stationary collar of claim 6, wherein the rounded face has a bulge at one end of the rounded face.

8. The stationary collar of claim 6, wherein a plurality of notches are formed into the rounded face.

9. A track roller for use within an undercarriage of a track-type machine, the track roller comprising:
a stationary shaft;
a bearing positioned around a center portion of the stationary shaft;
a roller shell, the roller shell positioned about the bearing;
a stationary collar attached to each end of the stationary shaft and secured to the stationary shaft by a lock pin, the stationary collar having a first portion of the stationary collar and a second portion of the stationary collar, the second portion of the stationary collar being an asymmetrical design when compared to the first portion of the stationary collar;
a thrust ring around the stationary shaft and located between the stationary collar and the roller shell;
a first metal face seal located within a first vacant section of the stationary collar, the first metal face seal having a first sealing component in contact with the first metal face seal and the stationary collar; and
a second metal face seal located in a second vacant section between the stationary collar and the roller shell, the second metal face seal having a second sealing component in contact with the second metal face seal and the roller shell.

10. The track roller of claim 9, wherein the first portion of the stationary collar has a upper protrusion and a top collar housing as part of the first portion of the stationary collar, the top collar housing of the first portion of the stationary collar being part of the first vacant section which houses the first metal face seal and the first sealing component.

11. The track roller of claim 9, wherein the second portion of the stationary collar has a lower protrusion and a bottom collar housing as part of the second portion of the stationary collar, the bottom collar housing of the second portion of the stationary collar being part of the first vacant section which houses the first metal face seal and the first sealing component.

12. The track roller of claim 10, wherein the upper protrusion has a top surface, the top surface being a ramped surface providing an incline from one end of the upper protrusion to the other end of the upper protrusion, the roller shell located above at least part of the ramped surface and an upper labyrinth created from the space between the roller shell and the upper protrusion of the stationary collar.

13. The track roller of claim 10, wherein the upper protrusion has a side face, the side face being an angled face providing an incline from one end of the side face to the other end of the side face, the angled face being across from the roller shell and angled in relation to a horizontal position of the roller shell.

14. The track roller of claim 11, wherein the lower protrusion has a lower side face, the lower side face being a rounded face, the rounded face being across from the roller shell and rounded away from a horizontal position of the roller shell.

15. The track roller of claim 14, wherein the rounded face has a bulge at one end of the rounded face.

16. The track roller of claim 14, wherein a plurality of notches are formed into an outer edge of the rounded face.

17. The track roller of claim 9, wherein the roller shell extends over at least part of the first portion of the stationary collar and at least part of the second portion of the stationary collar, an upper labyrinth formed by the space between the first portion of the stationary collar and the roller shell and a bottom labyrinth formed by the space between the second portion of the stationary collar and the roller shell, the upper labyrinth being narrower to restrict access than the bottom labyrinth.

18. The track roller of claim 9, wherein a lubricant is present to aid performance and prevent wear of the bearing, the thrust ring, the first metal face seal, the first sealing component, the second metal face seal, and the second sealing component.

19. A method to remove a debris from a track roller during operation of a track-type machine, the method comprising:
providing a track roller having a roller shell and a stationary collar attached to a stationary shaft;
designing the stationary collar to have a first portion of the stationary collar and a second portion of the stationary collar, the second portion of the stationary collar being an asymmetrical design when compared to the first portion of the stationary collar;
ingesting the debris into an upper labyrinth formed between the first portion of the stationary collar and the roller shell;
rotating the roller shell so that the debris ingested into the upper labyrinth rolls along with the roller shell as the roller shell rotates;
dislodging the debris from the track roller as the roller shell rotates the debris towards a bottom labyrinth, the bottom labyrinth being formed from a larger space between the stationary collar and the roller shell; and
expunging the debris from the track roller with the aid of gravity as the roller shell rotates.

20. The method of claim 19, where the first portion of the stationary collar has an angled face facing the roller shell, the angled face aiding in the dislodging of debris as the roller shell rotates towards the second portion of the stationary collar.
